(19) United States
(12) Patent Application Publication
(10) Pub. No.: US 2005/0042065 A1
(43) Pub. Date: Feb. 24, 2005

(54) Substrate transfer device with cassettes

(76) Inventors: Cheng Doul Chuang, Miao-Li (TW); Chien-Sung Deng, Miao-Li (TW); Hung-Wen Yang, Miao-Li (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/925,287

(22) Filed: Aug. 23, 2004

(30) Foreign Application Priority Data
Aug. 22, 2003 (TW) 92123133

(51) Int. Cl. B65F 3/02

(52) U.S. Cl. 414/404

(57) ABSTRACT

A substrate transfer device (100) includes a base (1), a first and second cassettes (3, 5), and a push element (13). The first cassette includes two opposite side plates (36), a top plate (38) interconnecting the side plates, and two inwardly extending bottom flanges (31). The second cassette includes two opposite side plates (56), and a top and bottom plates (58) interconnecting the side plates. The side plates of the first and second cassettes each include supporting members (37, 57) protruding inwardly therefrom. The base supports the first and second cassettes thereon, and defines a central slide groove (17) therein. The push element includes a slide portion (135) and an urging portion (131). The slide portion can slide in the central slide groove. The urging portion can slide between the side plates of the first cassette, so as to push substrates in the first cassette into the second cassette.

### BACKGROUND OF THE INVENTION

1. Field of the Invention

The present invention relates to substrate transfer devices, and particularly to a substrate transfer device used to transfer substrates in batches.

2. Description of the Prior Art

Nowadays, various kinds of substrates including glass substrates are extensively used for LCDs (Liquid Crystal Displays), plasma displays and hybrid ICs (Integrated Circuits). In general, the substrates are loaded into a substrate cassette for storage or transportation. The cassette can conveniently hold a plurality of the substrates. This kind of means is in widespread use for carrying a plurality of substrates between fabrication stations in a factory or between factories.

However, it is troublesome to transfer the substrates between different cassettes. This is because the substrates are generally transferred one by one, either by hand or through a servo manipulator. The substrates are easily scraped or damaged in this process; for example, when an operator accidentally bumps a substrate while carrying it. In addition, the inefficiency of the process is significant when a large number of substrates need to be transferred.

Therefore, it is desired to provide a substrate transfer device which overcomes the above-described disadvantages by transferring the substrates in batches.

### SUMMARY OF THE INVENTION

An object of the present invention is to provide a substrate transfer device for transferring a plurality of substrates in batches, and with minimal risk of damage to the substrates.

In order to achieve the above-described object, a substrate transfer device in accordance with the present invention comprises a base, a first and second cassettes, and a push element. The first cassette includes a pair of opposite side plates, a top plate interconnecting the side plates, and a pair of bottom flanges extending inwardly from bottoms of the side plates respectively. The second cassette includes a pair of opposite side plates, and a pair of top and bottom plates interconnecting the side plates. The side plates of both the first and second cassettes each include supporting members protruding inwardly therefrom. The base supports the first and second cassettes thereon, and defines a central slide groove therein. The push element includes a slide portion and an urging portion. The slide portion can slide in the central slide groove. The urging portion can slide between the side plates of the first cassette, so as to push substrates in the first cassette into the second cassette.

Other objects, advantages, and novel features of the present invention will be apparent from the following detailed description of preferred embodiments thereof with reference to the attached drawings, in which:

### BRIEF DESCRIPTION OF THE DRAWINGS

FIG. 1 is an isometric view of the substrate transfer device according to the present invention;

FIG. 2 is an exploded view of the substrate transfer device of FIG. 1; and

FIG. 3 is similar to FIG. 1, but not showing first and second cassettes of the substrate transfer device.

### DETAILED DESCRIPTION OF THE PRESENT INVENTION

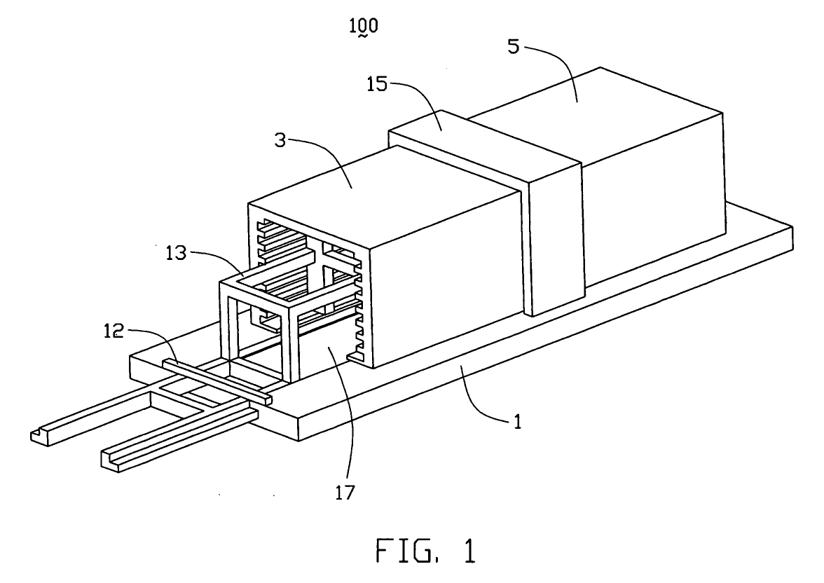

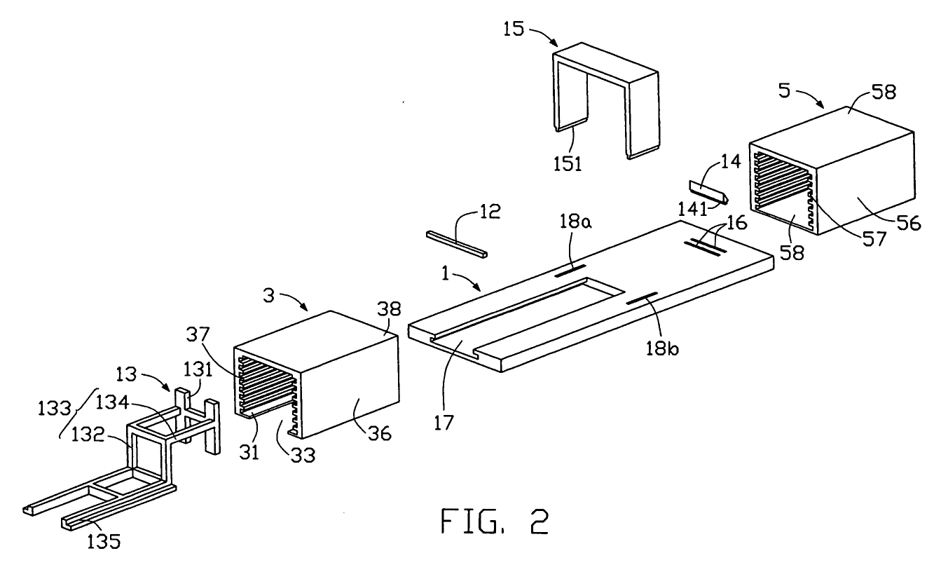

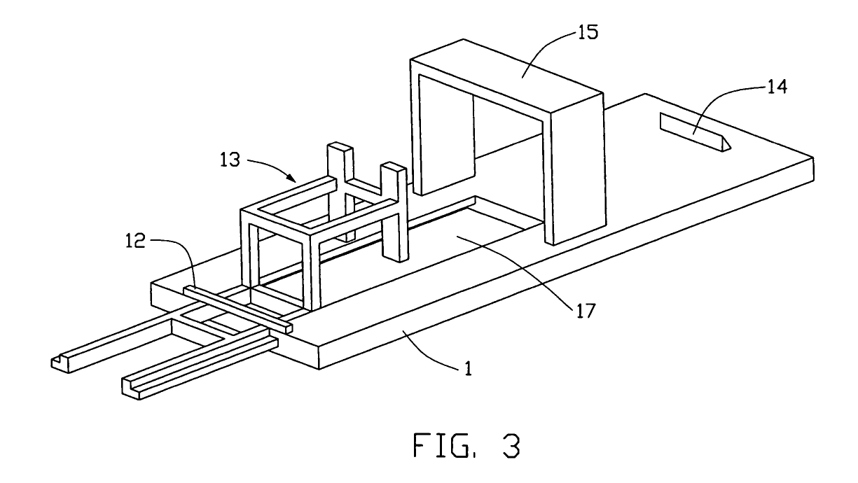

Referring to FIGS. 1, 2 and 3, a substrate transfer device 100 comprises a base 1, a first cassette 3, a second cassette 5, and a push element 13.

The first cassette 3 includes a pair of opposite side plates 36, a top plate 38 interconnecting the side plates 36, and a pair of bottom flanges 31 extending inwardly from bottoms (not labeled) of the side plates 36 respectively. The bottom flanges 31 define an opening 33 therebetween. The side plates 36 each include supporting members 37 protruding inwardly therefrom, for accommodating substrates (not shown) in the first cassette 3.

The second cassette 5 includes a pair of opposite side plates 56, and a pair of top and bottom plates 58 interconnecting the sides plates 56. The side plates 56 each include supporting members 57 protruding inwardly therefrom, for accommodating the substrates in the second cassette 5.

The base 1 supports the first and second cassettes 3, 5 thereon, and defines a central slide groove 17 in approximately an end half portion thereof that corresponds to the first cassette 3. The central slide groove 17 has a generally T-shaped profile. A width of the central slide groove 17 is substantially the same as a width of the opening 33 of the first cassette 3. A pair of latch holes 18a, 18b is defined in a middle portion of the base 1, at opposite lateral sides of an inner end of the central slide groove 17 respectively. A pair of transverse latch slots 16 is defined in an end of the base 1 distal from the central slide groove 17. A stop tab 14 with a bottom locating latch 141 is also provided. The locating latch 141 can be engaged in a selected one of the latch slots 16.

The push element 13 includes a slide portion 135 and an urging portion 131. The slide portion 135 can slide in the central slide groove 17 of the base 1. The urging portion 131 can slide between the side plates 36 of the first cassette 3, so as to push substrates in the first cassette 3 to the second cassette 5. The push element 13 further includes a connection portion 133. The connection portion 133 includes a pair of vertical bars 132 connecting with the slide portion 135, and a pair of horizontal bars 134 connecting with the urging portion 131.

The substrate transfer device 100 may optionally further comprise a generally inverted U-shaped fastening frame 15 and a stop bar 12. The fastening frame 15 has a pair of locating latches 151 at bottom ends thereof respectively.

The substrate transfer device 100 is made of material that can resist electrostatic discharge.

In assembly and preparation for use of the substrate transfer device 100, the substrates to be transferred are placed on the supporting members 37 of the first cassette 3. The first cassette 3 and the second cassette 5 are placed closely adjacent each other on the base 1. The locating latches 151 of the fastening frame 15 are fixed in the latch holes 18a, 18b. The fastening frame 15 thereby fastens the first and second cassettes 3, 5 together on the base 1. The locating latch 141 of the stop tab 14 is fixed in a selected one of the latch slots 16, thereby locating and fastening the second cassette 5 on the base 1. The slide portion 135 of the push element 13 is slidably received in the central slide groove 17 of the base 1, with the urging portion 131 positioned above the bottom flanges 31 of the first cassette 3. The push element 13 is thus movably assembled with the base 1 and the first cassette 3. The stop bar 12 is transversely fastened to the base 1 above the slide portion 135, so as to prevent the slide portion 135 from sliding completely out from the central slide groove 17.

In operation, the push element 13 is pushed toward the second cassette 5, with the slide portion 135 sliding in the central slide groove 17. The urging portion 131 thus pushes the substrates in the first cassette 3 into the second cassette 5 in a single batch.

The main advantage of the substrate transfer device 100 is that the substrates in the first cassette 3 are directly transferred to the second cassette 5 in a single batch, rather than one by one. The transfer is short and smooth, with little risk of the substrates sustaining scraping or damage. In addition, the efficiency of the process is particularly high when a large number of substrates need to be transferred.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A substrate transfer device comprising:
a first cassette having a pair of opposite side plates, a top plate interconnecting the side plates, and a pair of bottom flanges extending inwardly from bottoms of the side plates respectively, the sides plates each comprising supporting members protruding inwardly therefrom;
a second cassette having a pair of opposite side plates and a pair of top and bottom plates interconnecting the sides plates, the sides plates each comprising supporting members protruding inwardly therefrom;
a base supporting the first and second cassettes thereon, and defining a slide groove therein; and
a push element comprising a slide portion and an urging portion;
wherein the slide portion can slide in the slide groove, and the urging portion can push substrates in the first cassette into the second cassette.

2. The substrate transfer device as claimed in claim 1, further including a fastening frame for fastening the first and second cassettes together on the base.

3. The substrate transfer device as claimed in claim 2, wherein the base further defines a pair of latch holes at opposite lateral sides thereof, and the fastening frame includes a pair of locating latches at bottom ends thereof respectively fixed in the latch holes.

4. The substrate transfer device as claimed in claim 3, wherein the fastening frame has an inverted U-shape.

5. The substrate transfer device as claimed in claim 1, wherein the base further includes a stop tab attached on a longitudinal end thereof for locating and fastening the second cassette on the base.

6. The substrate transfer device as claimed in claim 5, wherein the base further defines at least one latch slot in a longitudinal end thereof, and the stop tab has a locating latch that can be engaged in said latch slot for locating and fastening the second cassette.

7. The substrate transfer device as claimed in claim 1, further including a stop bar transversely fastened to the base above the slide portion, for preventing the slide portion from sliding completely out from the slide groove.

8. The substrate transfer device as claimed in claim 1, wherein the push element further comprises a connection portion interconnecting the slide portion and the urging portion.

9. The substrate transfer device as claimed in claim 8, wherein the connection portion includes a pair of vertical bars connecting with the slide portion, and a pair of horizontal bars connecting with the urging portion.

10. The substrate transfer device as claimed in claim 1, wherein the slide groove has a generally T-shaped profile.

11. The substrate transfer device as claimed in claim 1, wherein the bottom flanges of the first cassette define an opening therebetween, and a width of the opening is substantially the same as a width of the slide groove.

12. The substrate transfer device as claimed in claim 1, wherein the substrate transfer device is made of material that can resist electrostatic discharge.

13. A substrate transfer device assembly comprising:
a first cassette including two opposite spaced first side walls with first supporting devices thereon to hold a plurality of parallel arranged substrates thereon between said two first side walls;
a second cassette including two opposite spaced second side walls with second supporting devices thereon for holding said plurality of parallel arranged substrates thereon between said two first side walls;
said first cassette and said second cassette being arranged with a rear opening of said first cassette and a front opening of said second cassette being close to and aligned with each other under a condition that the first supporting devices are aligned with the corresponding second supporting devices in a front-to-back direction, respectively; and
a push element projecting into the first cassette from an exterior to push the substrates move in the front-to-back direction from the first cassette into the second cassette.

14. The assembly as claimed in claim 13, wherein said first cassette lacks a bottom wall so as to allow the push element to upwardly enter an interior of the cassette.

15. The assembly as claimed in claim 13, wherein a fastening frame surrounds a rear portion of the first cassette and a front portion of the second cassette to assure the rear opening of the first cassette is aligned with front opening of the second cassette in the front-to-back direction.

16. The assembly as claimed in claim 13, wherein both said first cassette and said second cassette are seated upon a planar base.

17. The assembly as claimed in claim 16, wherein said base is equipped with guiding means for assuring said push element moves along the front-to-back direction without tilting.

18. A method of transferring substrate from one cassette to another one, comprising steps of:
providing similar first and second cassettes each with a pair of side walls having supporting devices thereon;
equipping said first cassette with a plurality of substrates arranged on the corresponding supporting devices in a spatial parallel relation with one another;
aligning the first cassette with the second cassette to have a rear opening of the first cassette aligned with a front opening of the second cassette in a front-to-back direction wherein the supporting devices of the first cassette are aligned with the corresponding ones of the second cassettes in said front-to-back direction; and
forcing the substrates to move along said front-to-back direction from the first cassette to the second cassette.

19. The method as described in claim 18, further including a step of providing a planar base to support said first and second cassettes.

20. The method as described in claim 18, further including a step of providing a fastening frame to hold the first cassette and the second cassette in alignment with each other.
